(19) United States
(12) Patent Application Publication
(10) Pub. No.: US 2025/0347970 A1
(43) Pub. Date: Nov. 13, 2025

(54) SOLID-STATE FREQUENCY AGILE FILTER FOR LIDAR: MULTILAYER OPTICAL DESIGN AND EXOTIC PHASE-CHANGE MATERIALS-BASED ACTIVE TUNING

(71) Applicant: UNITED STATES OF AMERICA AS REPRESENTED BY THE ADMINISTRATOR OF NASA, Washington, DC (US)

(72) Inventors: Hyun Jung Kim, Yorktown, VA (US); Amin R. Nehrir, Yorktown, VA (US); Calum Williams, Exeter (GB); John A. Smith, Norfolk, VA (US)

(21) Appl. No.: 18/662,368

(22) Filed: May 13, 2024

(51) Int. Cl. G02F 1/21; G01S 7/481

(52) U.S. Cl. CPC G02F 1/213; G02F 1/218; G01S 7/4816

(57) ABSTRACT

An all-solid-state frequency agile filter (“AF2”) based on exotic phase change materials (PCM) and Fabry-Perot (FP) multilayer optical design is described herein. AF2 embodiments herein are useful for LIDAR (Light Detection and Ranging) applications, including DIAL (Differential absorption LIDAR), based on the AF2's benefits of fast tunability (GHz˜MHz), no moving parts, wide-range tunability, ultra-narrow bandwidth, all-solid-state, and polarization insensitivity. An AF2 consists of a single filter and a single detector, independent of the number of wavelengths needed to transmit for sampling the atmospheric water vapor, ozone, and trace gases absorption line at various spectral locations.

### STATEMENT REGARDING FEDERALLY SPONSORED RESEARCH OR DEVELOPMENT

The invention described herein was made in the performance of work under NASA contracts and by an employee/employees of the United States Government and is subject to the provisions of the National Aeronautics and Space Act, Public Law 111-314, § 3 (124 Stat. 3330, 51 U.S.C. Chapter 201) and 35 U.S.C. § 202, and may be manufactured and used by or for the Government for governmental purposes without the payment of any royalties thereon or therefore. In accordance with 35 U.S.C. § 202, the contractor elected not to retain title.

### BACKGROUND OF THE INVENTION

The state-of-the-art in narrowband optical filtering is the thin film interference filter—an established passive filtering technology, whereby separate filters are required for each wavelength of interest. Alternate electro-optical approaches include liquid-crystal tunable filters and acousto-optical tunable filters. Both offer tunable filtering, yet their adoption rates remain low due to their inherent limitations including e.g., strong polarization sensitivity, low light throughput (efficiency), limited spectral coverage, slow switching speed (milliseconds), and high cost.

Multilayer Fabry-Perot (FP) bandpass filter design is well established with mass-produced filters still offering unrivalled optical performance when compared to alternative spectral filter technologies. dielectric-mirrors open up a stopband, with the resonant cavity providing a passband with narrow full-width-half-maximum (FWHM); layer thicknesses for each are designed for the center wavelength (CWL) of operation. However, once manufactured, these FP-bandpass filters typically offer no straightforward means to actively tune their spectral properties.

Currently, passive filters based on thin film interference designs are used for differential absorption lidar (“DIAL”). FIGS. 1a and 1b illustrate the prior art approach to

DIAL spectral filtering. The passive filter has broad transmission function which integrates an unacceptable amount of solar radiation and hence reduces the measurement SNR. A narrowband and frequency agile filter is required to reduce the amount of solar background light incident on the detector and that can also track the wavelength of the DIAL transmitter to optimize the throughput. In accordance with FIG. 1a, narrowband spectral filtering is typically required to boost signal-to-noise in the receiver subsystem. To achieve this in DIAL, a narrowband (single-to-few-cavity) Fabry-Perot-based bandpass filter with high out-of-band blocking 5ₐ, and air-space etalon 10ₐ are used in conjunction. The resultant filtering response 15ₐ is a convolution of bandpass filter and etalon response 5_{b} in FIG. 1b, whereby the former provides an narrow envelope function 5_{b} centered around λ₀ for the ‘comb-function’ 10_{b} of the etalon. This final response 15_{b} has both large out-of-band blocking and ultra-narrowband transmission modes. The etalon output (i.e. free spectral range and peak width) is typically controlled through thermal stabilization of the etalon's air-cavity, in order to spectrally coincide (match) the two-wavelength output of the laser to the free spectral range of the etalon.

For ‘active’ spectral tunability, two operating mechanisms are generally utilized: (1) modifying the physical-optical properties of constituent material/s, or (2) mechanically altering the device design/system setup. For the former, the optical properties of materials can be tuned by: (a) employing materials with adjustable refractive indices (i.e. index modulation capability), and or (b) incorporating patterns (i.e. gratings, waveguides etc.), then changing geometry (size, shape etc.). For (a), liquid crystals (LCs)—with voltage controllable birefringence properties—have been widely implemented (e.g. LC-Lyot filters) to provide spectral filtering. However, this costly approach is inherently polarization-dependent, offers low transmission efficiencies, operates primarily in the visible—as LCs typically exhibit vibrational-absorption modes in the IR—and provides relatively slow switching speeds (˜kHz). Another related technology is acousto-optic tunable filters (AOTFs), whereby the optical properties of a birefringent crystal, and subsequent diffraction output can be controlled through acoustic waves generated via applied RF signals. This approach, albeit fast-switching (˜MHz), is costly, requires bulky hardware, has small entrance apertures and hence is generally unsuitable for wide-field imaging purposes. Over recent years, plasmonic/all-dielectric nanostructure arrays have been developed for compact, ultra-thin spectral filters. These devices provide spectral filtering through the excitation of electric/magnetic resonances in tailored metallic or high-index dielectric nanostructure arrays. Nonetheless, for bandpass filters, their transmission response is typically broad with low efficiencies; polarization-dependent multipolar (additional) modes are often excited in the same spectral region, and ultra-high resolution lithographic techniques (e.g. deep/extreme UV) are required for commercial adoption.

### BRIEF SUMMARY OF THE INVENTION

One exemplary embodiment of the invention is an all-solid-state frequency agile filter comprising: a substrate exhibiting transparency in a wavelength band selected within the range of 500 nm to 15 μm; multiple cavities, including at least one tunable cavity comprising an exotic phase change material. Such agile filter may also comprise multiple optical layers.

Another exemplary embodiment of the invention is A differential absorption light detection and ranging filter comprising the following solid-state material optical layers: a substrate exhibiting transparency in a wavelength band selected within the range of 500 nm to 15 μm; a first distributed Bragg reflector (DBR) consisting of N bi-layers of alternating high and low index materials; a first electrically tunable cavity, including an exotic phase change material;

a second distributed Bragg reflector (DBR) consisting of N bi-layers of alternating high and low index materials; a first passive cavity; a third distributed Bragg reflector (DBR) consisting of N bi-layers of alternating high and low index materials; a passive etalon-like cavity; a fourth distributed Bragg reflector (DBR) consisting of N bi-layers of alternating high and low index materials; a second passive cavity; a fifth distributed Bragg reflector (DBR) consisting of N bi-layers of alternating high and low index materials; a second electrically tunable cavity, including an exotic phase change material; and a sixth distributed Bragg reflector (DBR) consisting of N bi-layers of alternating high and low index materials.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIGS. 1a and 1b illustrate a prior art approach to DIAL spectral filtering;

FIGS. 2a and 2b illustrate a prior art PCM tunable filter;

FIGS. 3a, 3b and 3c illustrate representative operating modes of the PCM tunable filter of FIG. 2a;

FIGS. 4a, 4b, 4c and 4d provide a detailed example of a prior art PCM tunable filter;

FIGS. 5a and 5b illustrate a first AF2 embodiment useful for DIAL applications in accordance with embodiments herein; and

FIGS. 6a and 6b illustrate a second AF2 embodiment useful for DIAL applications in accordance with embodiments herein.

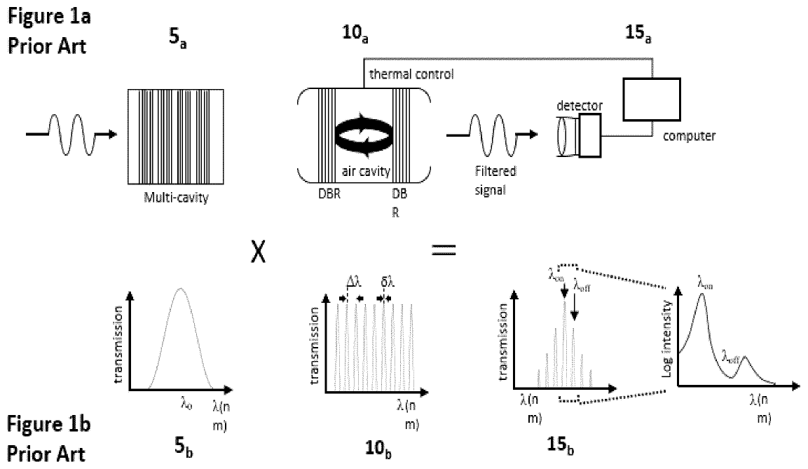

### DETAILED DESCRIPTION OF THE INVENTION

### Acronyms, Terms and Definitions

AF2: Agile filter.
BP: Band pass.
CWL: Center wavelength.
DBR: distributed Bragg reflector.
DIAL: Differential absorption LIDAR.
FP: Fabry-Perot.
HL: high-low index.
LIDAR: Light Detection and Ranging.
PCM: phase change material.
SmallSat: small satellite.
SNR: Signal-to-noise ratio.
SWAP-C: size, weight, power consumption and cost.

It is to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The embodiments described herein are directed to an all-solid-state frequency agile filter (“AF2”) based on exotic phase change materials (PCM) and Fabry-Perot (FP) multiple optical layer or “multilayer” optical design. One or more AF2 embodiments herein is useful for LIDAR (Light Detection and Ranging) applications, including DIAL (Differential absorption LIDAR), based on the AF2's benefits of fast tunability (GHz˜MHz), no moving parts, wide-range tunability, ultra-narrow bandwidth, all-solid-state, and polarization insensitivity. The embodiments herein may provide for an AF2 that includes a single filter and a single detector design, independent of the number of wavelengths needed to transmit for sampling atmospheric water vapor, ozone, and trace gases absorption line at various spectral locations.

The AF2 is based on use of an exotic phase-change material (PCM)—which is a material that exhibits a large reversible refractive index shift through an applied energetic stimulus; this is non-volatile, in that no additional energy is required to maintain its state. Through the integration of an exotic PCM (e.g., GeSbTe, SbS) as an ‘active’ optical cavity in the filter, the center wavelength (CWL) of AF2 is tunable because the CWL tuning is a function of the refractive index of the optical cavity, which is a function of the PCM state (i.e. amorphous or crystalline). This behavior is electronically controlled and can be operated time-sequentially (e.g., by nanosecond) in the electronics, which is a capability not possible with existing, conventional solutions.

Certain embodiments herein use chalcogenide-based materials, as an exotic PCM for the phase change cavity embedded between distributed Bragg reflectors (DBRs), forming an FP arrangement or multiple optical layer design. Herein, the chalcogenide material is chemical compound consisting of at least one chalcogen anion, O, S, Se, Te, and Po—thus, the compound may be selected from a group such as GeSbTe, SbS, and GeSbSeTe. The AF2 embodiments described herein implement the chalcogenide phase-change cavity embedded between DBRs (distributed Bragg reflectors) to enable spectrally-tunable (bi-stable) all solid-state FP-bandpass filters operating across the visible to MWIR waveband, e.g., broadly 500 nm-15 μm and including NIR (near infrared, 0.7-1.0 μm) and SWIR (short-wave infrared, 1-3 um) bands of interest as would be understood by those skilled in the art. The optical path length of the PCM cavity, hence resultant passband center wavelength (CWL), is spectrally red-shifted under phase transformation due to PCMs induced refractive index modulation, which undergoes a linear increase in refractive index from ˜3.0 to ˜6.0. Therefore, through external stimuli, the AF2's CWL can be spectrally switched to two different states (passbands). This process is reversible.

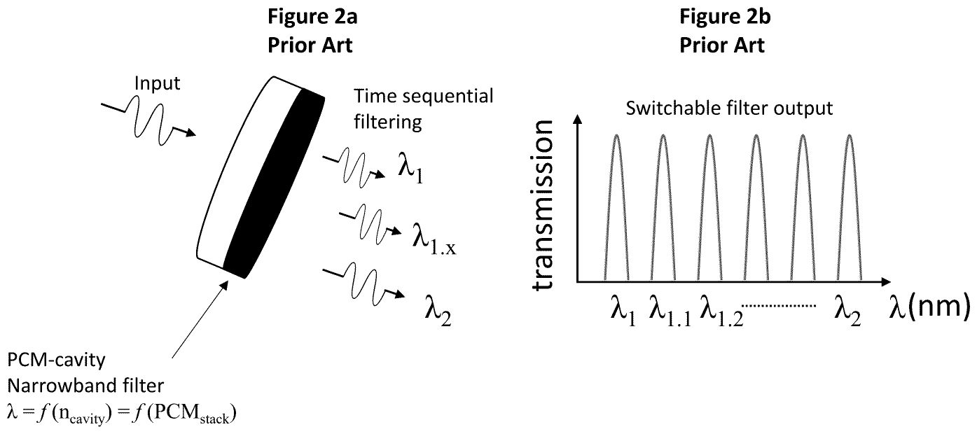

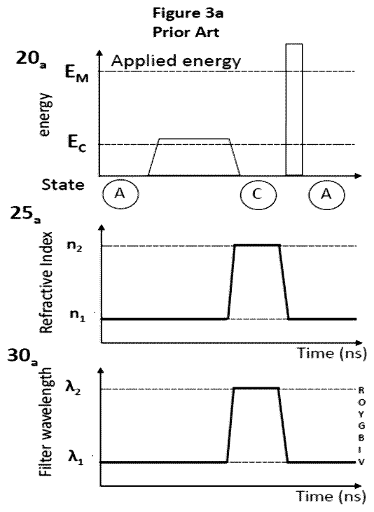

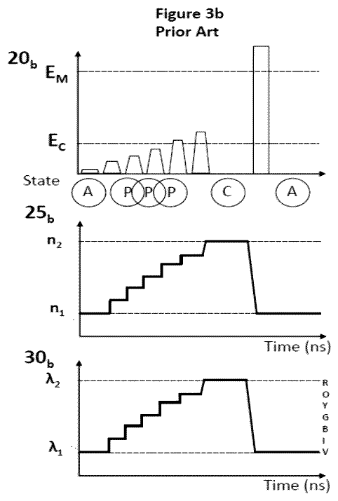

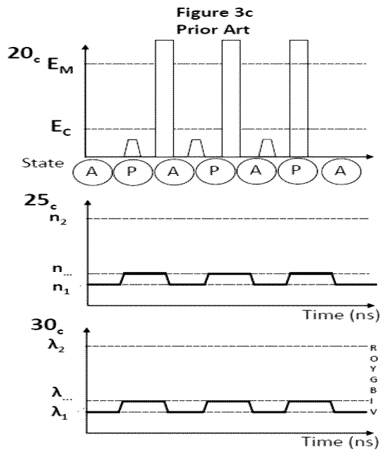

An all-solid-state spectrally tunable bandpass filter may be achieved through the integration of a PCM FIG. 2a (e.g., GeSbTe, SbS, and GeSbSeTe—depending on specific requirements) as an ‘active’ cavity in a FP filter. The center wavelength of operation is a function of the optical path length, hence refractive index of the cavity, which is a function of the PCM state (i.e., amorphous, partial crystallinities or fully-crystalline). This behavior is electronically controlled and can be operated time-sequentially (e.g., in nanosecond pulse control) in the electronics (FIG. 2b). The PCM's crystallization and hence refractive index is controlled through applied energy, whereby a critical integrated energy (E_{c}) (e.g. through electrode or optical pulse) must be applied to transition the PCM from amorphous to crystalline. A larger ‘reset pulse’ of melt energy (Eₘ) is then required to ‘melt’ the material back to amorphous. Each state has an associated varying refractive index, which when using the PCM as a bandpass cavity, controls the center wavelength of operation. As a result, the PCM-filter device can be operated in multiple modes, as illustrated in FIGS. 3a, 3b and 3c including: amorphous (shown by circled A) to fully-crystalline (shown by circled C) 20ₐ (i.e. PCM cavity: index_low (n₁) to index_high (n₂), 25ₐ with wavelengths overlaid in 30ₐ), FIG. 3a; amorphous, a series of partial crystallinities (shown by circled P) to fully-crystalline 20_{b} (i.e. PCM cavity: index_low, index_mid1, index_mid2 . . . to index_high, 25_{b} with wavelengths overlaid in 30_{b}), FIG. 3b and amorphous, to partial crystallinity_N 20_{c} (i.e. PCM cavity: index_low, index_midN, 25_{c} with wavelengths overlaid in 30_{c}), FIG. 3c.

Recently, phase change materials (PCMs) have gained interest as a new platform for tunable optical devices due to their pronounced refractive index contrast (between disordered-amorphous and ordered-crystalline states), fast switching speeds, and good thermal stability. The prototypical chalcogenide PCM, such as GeSbTe (GST), GeSbSeTe (GSST), or SbS, is non-volatile, can be reversibly switched on a nanosecond timescale, and exhibits large index modulation (˜2.4) across visible to mid-wave IR (MWIR), including NIR (near infrared, 0.7-1.0 μm) to SWIR (short-wave infrared, 1-3 μm). As an example, when GST is heated above its glass transition temperature, through laser pulse or electronic excitation, it produces a thermal transition occurring through nucleation and crystallization: 150° C. for face-centered cubic (FCC) packing, 360° C. for hexagonal close packed (HCP) growth. Re-amorphization is achieved by heating the material above its melting temperature (632° C.) followed by quenching. This optical contrast is a key property of PCMs for its widespread commercial application in optically rewritable data storage device and increasingly common usage in tunable/reconfigurable micro-optical devices such as waveguides, variable-focal lenses and filters. PCMs maintain their structural state and only require energy during the switching process, which is a clear advantage over liquid crystals and mechanically tuned photonic devices. Moreover, PCM is both cost-effective and scalable for large-area integration and exhibits tunable optical properties across broad wavebands.

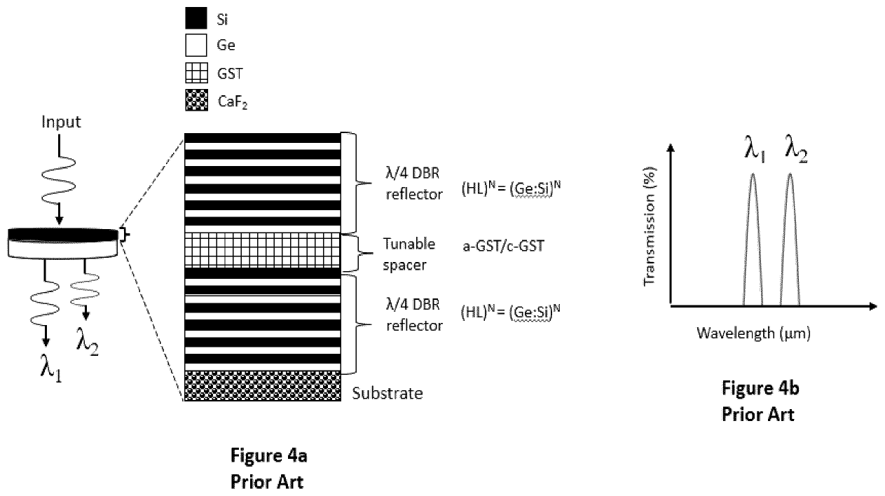

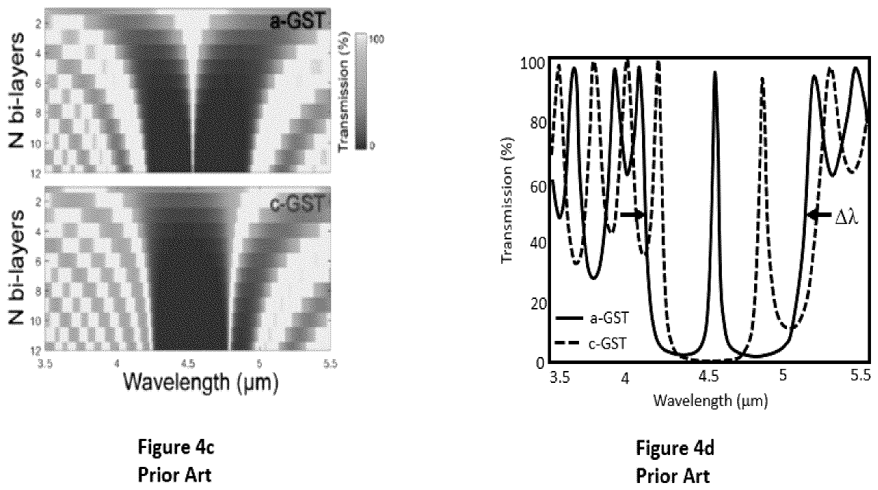

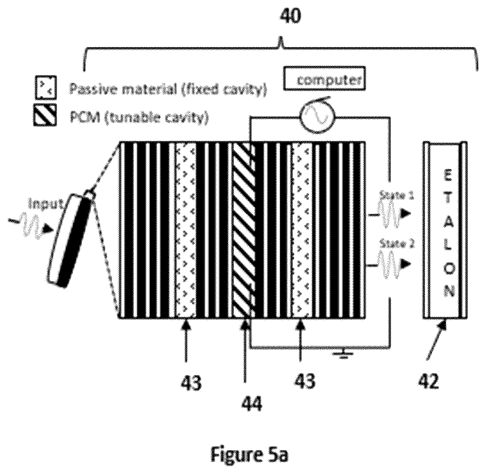

As described in the article by Calum Williams, et al., “Tunable mid-wave infrared Fabry-Perot bandpass filters using phase-change GeSbTe,” Vol. 28, No. 7/30 Mar. 2020/Optics Express, which is incorporated herein by reference, FIGS. 4a, 4b, 4c and 4d provide a detailed example of a base PCM-filter device. FIG. 4a is a multi-layer tunable Fabry-Perot bandpass filter layer design, with thicknesses of filter materials (t_{GST}) indicated, whereby the center wavelength (λ₁, or λ₂) of the narrowband transmission response will spectrally shift, in a reversible process, depending on the spacer's optical thickness, hence GST crystallinity (i.e., refractive index) (FIG. 4b). Further to FIG. 4a, thin-film optical bandpass filters are composed of a single-spacer (resonant cavity) between two multi-layer dielectric mirrors. The dielectric mirrors, e.g., distributed Bragg reflectors (“'DBRs”), consist of a series of alternating high-and-low index materials (i.e. N bi-layers) with ¼-wave optical thickness, which provides a spectral ‘rejection region’. An embedded spacer opens up a transmission passband, with optical thickness governing the filter's CWL of operation. A material's optical thickness is dependent on its refractive index. By utilizing the phase-change material GST—which exhibits a significant index modulation across the waveband of target to tune-as the spacer material, it is possible to control the passband CWL through the phase transformation of GST. For bandpass filters operating across bands of interest, Ge (H—high index) and Si (L—low index) are selected as the DBR materials, with CaF₂ as the substrate. In this particular example, GST is then utilized as a tunable spacer material, with capability to operate in either its amorphous (a-GST) or crystalline (c-GST) state (induced through external stimuli). One skilled in the art will appreciate that any substrate material may be used so long as it is transparent in the spectral bands of interest. Some examples of other material candidates include but are not limited to: germanium, silicon, potassium bromide, sodium chloride, magnesium fluoride, sapphire, zinc selenide, and zinc sulfide. Fabrication of the AF2 filters described herein is via conventional thin film deposition techniques.

FIG. 4c is a simulation of the effect of N bi-layers on the transmission response of the filter for a-GST and c-GST spacer layers with quarter-wave DBR stacks. And FIG. 4d is a simulation of the 6-bilayer designed FP filter. DBR=distributed Bragg reflector, BP=bandpass, HL=high-low index bi-layer, Δλ=blocking wavelength range (rejection region).

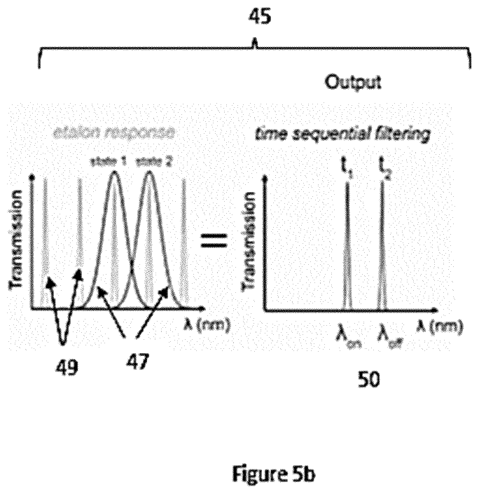

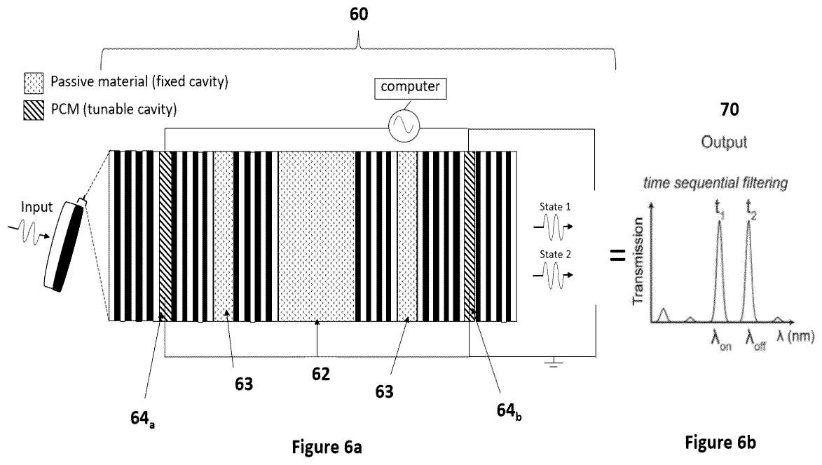

The solid-state frequency agile filter may be used for DIAL, the differential attenuation between two closely spaced spectral positions on a selected gas/molecular absorption response through the two selected filter wavelengths (i.e. on-resonance and off-resonance switch) to map gas backscatter, hence atmospheric concentrations. FIGS. 5a, 5b and FIGS. 6a, 6b show filters designed in accordance with the embodiments herein, which allow the stringent DIAL filter requirements along with the active tunability; ultrafast-switching (˜100 ns), dual-spectral tunability (200˜400 pm) or wide-spectral tunability (500 nm˜15 μm), and narrowband (<20 pm), no settling time, polarization insensitive, and high transmittance (>70%) performance. The active and robust tunability of the filters allow a mission-ready spaceborne DIAL for the global and rapid profiling of atmospheric gases and provides an increase in detectivity (SNR), decrease the readout speed, and substantial reduction SWAP-C.

FIGS. 5a and 5b are directed to a first AF2 embodiment 40 which includes a triple-cavity bandpass filter with etalon 42, two fixed cavities (formed from passive material) 43, and one (or more—i.e., or multiple) PCM (tunable) cavities 44, with center of wavelength of operation being electrically-controllable. The resultant filtering response 45 is the tunable response 47 convolved with etalon comb-function 49, hence time sequential ultra-narrowband filtering is possible 50.

FIGS. 6a and 6b are directed to a second AF2 embodiment 60. This embodiment includes a multi-cavity PCM bandpass filter containing two tunable PCM-cavities 64_{a,} 64_{b}, two fixed cavities (formed from passive material) 63 and an embedded all-solid-state passive etalon-like cavity 62 with material chosen for ultra-low bandwidth, as would be known to one skilled in the art. In operation, the cavity with center of wavelength of operation is electrically-controlled. The embedded solid-state etalon (i.e. longer passive cavity) response is convolved with the additional smaller optical cavities (both passive and PCM) in the device. The resultant filtering response is an electrically controlled time sequential narrowband response 70.

In comparison to conventional approaches, the AF2 filters described herein provide: unrivalled tunable filtering across multiple wavebands, several orders-of-magnitude faster switching speeds, no sensitivity to the incoming state of polarization, and an all solid-state solution capable of withstanding the harsh space environment. All of the aforementioned traits result in a substantial reduction in size, weight, power and cost (SWaP-C) and offer a further unprecedented advantage to spaceborne LIDAR.

The active and robust tunability of the AF2 filters described herein allows a mission-ready space-borne DIAL for the global and rapid profiling of atmospheric gases and provides to increase in detectivity (SNR), decrease the readout speed, and substantial reduction SWaP-C compared to the airborne-based DIAL.

The filters exemplified herein have numerous applications. For example when used for archiving fast-tuning, broad-wavelength tuning, and low-cost active measurements provided to climate models, scientists can have an improved understanding of species impacts on the climate. The filters can be implemented as flying instruments (SmallSat-based) that complement other observing systems. By utilizing SmallSat free-flyer, the filter technology significantly reduces the mass, cost, and size of science missions while allowing new filtering through the filter's active tuning with super narrow bandwidth.

The single frequency AF2 allows for SmallSat-based spaceborne DIAL from decreasing cost, risk, and reducing systematic bias that could result from non-linear time dependent degradation of the different detectors.

DIAL is an important measurement technique for mapping range-resolved concentrations of trace/greenhouse gases such as, H₂O and CH₄ in the atmosphere which are important to many processes that underpin weather and climate systems, and improved measurements are required to improve inputs to numerical prediction models. Profiles of water vapor are critical for a deeper understanding of clouds responding to climate behavior and atmospheric contaminants. At present, DIAL systems are implemented using airborne approaches, e.g., by airplane, systems with passive filters which provide sufficient solar blocking, but do not scale to space where the atmospheric LIDAR signals are ˜3000 times weaker and the relative contribution of solar background noise is much higher. An improved filter with narrow passband that can track the transmitted wavelength of a water vapor DIAL transmitter is needed to enable a future space-based DIAL mission. DIAL requires differential attenuation between two closely spaced spectral positions on a selected gas/molecular absorption response through the two selected filter wavelengths (i.e. robust on-resonance and off-resonance switch speed) to map gas backscatter, hence atmospheric concentrations. The benefit of the embodied frequency agile filter is that only one filter and one detector is required regardless of the number of wavelengths needed to transmit for sampling the water vapor absorption line at various spectral locations. Spaceborne DIAL would provide, for the first time, direct and unbiased profiles of water vapor throughout the troposphere with high vertical resolution and global coverage. The embodied filters meet stringent filter requirements—including the need for fast-switching, ultra-narrowband near-infrared filters in DIAL. AF2 allows for several orders-of-magnitude increase in background reduction and hence increase in SNR; allows for use of a single frequency agile filter and one detector thereby decreasing the complexity of the retrieval and sensitivity to bias resulting from differential aging of the various detectors used in existing DIAL approaches and lowers the overall mission cost by reducing the number of complex components.

Further, the rapid tuning speed (nanosecond) of the PCM-based filters allows for real-time imaging spectroscopy of dynamic targets (e.g. turbulent plumes, aerosols, etc.). Such applications include characterization of rocket engine exhaust plumes and volcanic gases in the atmosphere. For example, the filters can be designed to operate across the mid-wave infrared; a critical spectral window containing a vast number of molecular vibrational absorption peaks (e.g. NO₂, CO₂, SO₂ etc.).

Next bulky motorized filter wheels—with each spectral channel a separate filter—currently used for multispectral imaging in missions, can be surpassed by replacement with a single actively tunable PCM-filter.

One skilled in the art will recognize the broad applicability of the above embodiments of filters to the hyperspectral imaging community at large, including thermal engineering, defense applications, missile technologies, in-situ biomedical imaging and food/drug inspection pipelines, etc. Using multiple bandpass filters for maximum out-of-band blocking, embodiments herein can have far-reaching applicability within the LIDAR community, from DIAL to range-finding LIDAR to doppler LIDAR, chemical sensing of exo-planet, and blackbody calibration. Filters may be designed to operate in visible, near-IR to mid-IR wavebands, and may be designed for ground-, aircraft- or space-based form factors.

What is claimed is:

1. An all-solid-state frequency agile filter system, comprising:
a substrate exhibiting transparency in a wavelength band selected within the range of 500 nm to 15 μm;
multiple cavities, including at least one tunable cavity comprising an exotic phase change material; and
multiple optical layers.

2. The all-solid-state frequency agile filter of claim 1, wherein the exotic phase change material is a chalcogenide material.

3. The all-solid-state frequency agile filter system of claim 2, wherein the chalcogenide material is a compound consisting of at least one chalcogen anion selected from the group consisting of O, S, Se, Te, and Po.

4. The all-solid-state frequency agile filter system of claim 3, wherein the compound is selected from the group consisting of GeSbTe, SbS, and GeSbSeTe.

5. The all-solid-state frequency agile filter system of claim 1, wherein the substrate is selected from the group consisting of calcium fluoride, germanium, silicon, potassium bromide, sodium chloride, magnesium fluoride, sapphire, zinc selenide, and zinc sulfide.

6. The all-solid-state frequency agile filter system of claim 1, wherein the multiple optical layers include a Fabry-Perot arrangement comprising multiple distributed Bragg reflectors (DBRs) each consisting of multi-layer dielectric mirrors.

7. The all-solid-state frequency agile filter system of claim 6, wherein each of the multiple cavities is embedded between distributed Bragg reflectors (DBRs).

8. The all-solid-state frequency agile filter system of claim 1, further including an etalon component.

9. The all-solid-state frequency agile filter system of claim 8, further including multiple passive cavities.

10. The all-solid-state frequency agile filter system of claim 9, including one tunable cavity and two passive cavities.

11. The all-solid-state frequency agile filter system of claim 1, including two tunable cavities and three passive cavities.

12. The all-solid-state frequency agile filter system of claim 1, wherein one of the three passive cavities is an etalon-like cavity.

13. The all-solid-state frequency agile filter system of claim 1, wherein the at least one tunable cavity is electrically tunable between a first and second state commensurate with transmission of a first and second wavelength.

14. The all-solid-state frequency agile filter system of claim 1, wherein the exotic phase change material is electrically reversible between an amorphous phase and a crystalline phase.

15. A differential absorption light detection and ranging filter comprising the following solid-state material layers:
a substrate exhibiting transparency in a wavelength band selected within the range of 500 nm to 15 μm;
a first distributed Bragg reflector (DBR) consisting of N bi-layers of alternating high and low index materials;
a first electrically tunable cavity, including an exotic phase change material;
a second distributed Bragg reflector (DBR) consisting of N bi-layers of alternating high and low index materials;
a first passive cavity;
a third distributed Bragg reflector (DBR) consisting of N bi-layers of alternating high and low index materials;
a passive etalon-like cavity;
a fourth distributed Bragg reflector (DBR) consisting of N bi-layers of alternating high and low index materials;
a second passive cavity;
a fifth distributed Bragg reflector (DBR) consisting of N bi-layers of alternating high and low index materials;
a second electrically tunable cavity, including an exotic phase change material; and
a sixth distributed Bragg reflector (DBR) consisting of N bi-layers of alternating high and low index materials.

16. The differential absorption light detection and ranging filter of claim 15, wherein the high index material is Ge and the low index material is Si.

17. The differential absorption light detection and ranging filter of claim 16, wherein N equals 6.

18. The differential absorption light detection and ranging filter of claim 15, wherein the exotic phase change material is a chalcogenide material.

19. The differential absorption light detection and ranging filter of claim 18, wherein the chalcogenide material is a compound consisting of at least one chalcogen anion selected from the group consisting of O, S, Se, Te, and Po.

20. The differential absorption light detection and ranging filter of claim 19, wherein the compound is selected from the group consisting of GeSbTe, SbS, and GeSbSeTe.
